(19) United States
(12) Patent Application Publication
(10) Pub. No.: US 2021/0154510 A1
(43) Pub. Date: May 27, 2021

(54) PLASTIC GEL MATERIAL FOR PREVENTING SPONTANEOUS COMBUSTION OF COAL

(71) Applicant: SHANDONG UNIVERSITY OF SCIENCE AND TECHNOLOGY, Qingdao City (CN)

(72) Inventors: Xiangming HU, Qingdao City (CN); Weimin CHENG, Qingdao City (CN); Mingyue WU, Qingdao City (CN); Yanyun ZHAO, Qingdao City (CN); Wei LU, Qingdao City (CN); Biao KONG, Qingdao City (CN); Di XUE, Qingdao City (CN)

(21) Appl. No.: 17/258,725

(22) PCT Filed: Dec. 30, 2018
(86) PCT No.: PCT/CN2018/125970

§ 371 Date: Jan. 7, 2021

(30) Foreign Application Priority Data
Nov. 26, 2018 (CN) 201811414505.7

(51) Int. Cl. A62D 1/00; C08K 11/00; C08K 3/34; C08K 5/1545; C08K 3/26; C08K 3/40; C08J 3/11; C08J 3/24; E21F 5/08

(52) U.S. Cl. CPC A62D 1/0064; C08K 11/005; C08K 3/346; C08K 5/1545; C08K 2003/262; C08K 3/40; C08J 3/11; C08J 3/24; E21F 5/08; C08K 3/26

(57) ABSTRACT

A plastic gel material for preventing spontaneous combustion of coal, including water, a crosslinking agent, a toughener, a coagulant, an aggregate and a water glass. The crosslinking agent (AlCit) is prepared by mixing a polyaluminum chloride solution and a citric acid solution then neutralizing the mixture with a sodium hydroxide solution. The coagulant is one or more of potassium bicarbonate, sodium bicarbonate, ammonium bicarbonate, sodium carbonate or glucono-δ-lactone (GDL). The toughener is one or more of pregelatinized starch, sodium alginate, carboxymethyl cellulose or polyacrylamide. The aggregate is coal ash or bentonite. The plastic gel has good water retention, toughness and inhibition performance, and helps avoid easy cracking and pulverization in inorganic silica gel consolidating bodies after losing water. The plastic gel can cover the surface of burning coal mass, reduce the temperature of the ignition source, heat radiation and production amount of CO, and have a fire extinguishing effect.

### TECHNICAL FIELD

The present invention relates to the technical field of fire preventing and extinguishing materials, in particular to a plastic gel material for preventing spontaneous combustion of coal.

### BACKGROUND

Spontaneous combustion of coal is a serious threat to the safe production of mines in China. Fires caused by spontaneous combustion of coal not only cause a large number of casualties and property losses, but also cause serious problems such as degradation of ecological environment, air pollution and the like. To prevent spontaneous combustion of coal, grouting, inhibitor spraying, inert gas injection, three-phase foam injection and colloid injection in goafs are widely used at home and abroad; and ventilation sealing is performed using cement foam injection or polymer foam injection for the areas in danger of high caving risks of roadways. While these technologies play an important role in ensuring safe production in mines, there are also some problems. For example, a slurry material (coal ash, yellow mud and the like) and water easily separate during the implementation of the traditional grouting technology, which will affect the normal production of a working face; physical inhibitors of halogen salt (MgCl₂, CaCl₂, ZnCl₂) are cheap, but their inhibition time is short; and chemical inhibitors, such as urea, diamine borate, diammonium phosphate, carbamate and the like, are not suitable for wide application due to their high price. The inert gases (CO₂, N₂) used in the technology of fire prevention and extinguishment with inert gas is easy to diffuse with air ventilation and cannot easily stay in the injected area. The three-phase foam has poor stability and cannot seal a fire area for a long time. Polymer foam used in ventilation sealing by spraying in roadway and by filling in high-caving-risk regions is high in cost, and releases heat during foaming, which may easily cause spontaneous combustion of coal or gas explosion.

Therefore, the existing fire preventing and extinguishing materials have different degrees of defects. In order to accelerate the control of existing fire areas and curb the occurrence of new fire areas, there is an urgent need to develop a new material for fire prevention and extinguishment in mines, so that a more effective fire preventing and extinguishing material is sought without following the existing theories and technical frameworks.

### SUMMARY

In order to solve the existing problems in fire extinguishing materials for preventing spontaneous combustion of coal, the present invention creatively proposes a new concept of “plastic gel for preventing spontaneous combustion of coal”. A plastic gel refers to a multi-component system prepared by firstly interweaving a three-dimensional cross-linking network formed by moderate crosslinking of a water-soluble polymer and a crosslinking agent with an inorganic silica gel network formed by a sodium salt water glass base material under the coagulation effect of sodium bicarbonate, and then doping an aggregate.

The present invention adopts the following technical solution:

A plastic gel material for preventing spontaneous combustion of coal includes water, a crosslinking agent, a toughener, a coagulant, an aggregate and a water glass.

Preferably, the water glass has a Baume degree of 20-40, a modulus of 2-4 and a mass concentration of 5-40%.

Preferably, the plastic gel material includes 52-80 wt % of water, 0.4-10 wt % of crosslinking agent, 0.01-3 wt % of toughener, 1-15 wt % of coagulant, 7-20 wt % of aggregate and 7-20 wt % of water glass.

Preferably, the crosslinking agent is prepared by firstly mixing a polyaluminum chloride solution and a sodium citrate solution and then adjusting a pH value of the mixture with an NaOH solution.

Preferably, the pH value is 5.95-6.05.

Preferably, a concentration of the polyaluminum chloride solution is 10-30 wt %, a concentration of the sodium citrate solution is 5-20 wt %, and the two solutions are mixed in a mass ratio of 3:1-1:4 to obtain an AlCit solution.

Preferably, the coagulant is one or more of potassium bicarbonate, sodium bicarbonate, ammonium bicarbonate, sodium carbonate and glucono-δ-lactone.

Preferably, the toughener is one or more of super absorbent resin, pregelatinized starch, sodium alginate, carboxymethyl cellulose and polyacrylamide.

Preferably, the aggregate is bentonite or coal ash.

In the above technical solution, the plastic gel has good water retention, toughness, inhibition performance and fire extinguishing performance, can effectively solve the problem of easy cracking and pulverization in traditional inorganic silica gel consolidating bodies after losing water, and has significant fire extinguishing effect.

The plastic gel is advantageous in fire prevention and extinguishment mainly in the following aspects:

(1) Under the action of the crosslinking agent, the polymer plasticizer in the plastic gel forms an organic/inorganic interpenetrating network with the water glass gel, which increases the toughness and strength of the gel, helping to the preservation of water and effectively solving the problems of poor toughness and easy cracking in the traditional water glass gel, and thus producing good ventilation sealing and cooling effects.

(2) The double-component slurry of the plastic gel is a medium-viscosity fluid. By adjusting the amount of the coagulant, the gel can be formed quickly to realize short-distance transportation or the gel forming time can be extended to realize long-distance transportation.

(3) The plastic gel fully utilizes cheap materials such as coal ash to reduce production costs, resulting in a wide application prospect.

Based on the above, different from the traditional water glass gel and polymer gel, the “plastic gel” has good fluidity, low cost, good toughness and high water retention, and thus, is an ideal fire preventing and extinguishing material.

The present invention has the following beneficial effects:

The plastic gel for preventing spontaneous combustion of coal according to the present invention has good water retention, toughness and inhibition performance, and effectively solves the problem of easy cracking and pulverization in traditional inorganic silica gel consolidating bodies after losing water. Compared with the traditional water glass gel, the plastic gel can cover the surface of burning coal masses, significantly reduces the temperature of the ignition source, the heat radiation and the production amount of CO, and has stable fire extinguishing effect, eliminating the reoccurrence of re-burning. In addition, the plastic gel can adhere to the cracks of the coal masses so as to achieve good ventilation sealing g effect.

### BRIEF DESCRIPTION OF THE DRAWINGS

FIG. 1 shows change trend of a water retention rate of a gel with a doping amount of a polymer.

FIG. 2 shows inhibition effect on spontaneous combustion of coal (a production amount of CO during programmed heating).

FIG. 3 shows microstructures of gels (a. traditional water glass gel, b. plastic gel 1, c. plastic gel 2, d. plastic gel 3, e. plastic gel 4).

FIG. 4 is a schematic XRD diagram of white agglomerates.

### DETAILED DESCRIPTION OF THE EMBODIMENTS

The present invention will be specifically described below in conjunction with specific embodiments and accompanying drawings:

### Embodiment 1

10 L of a 20 wt % polyaluminum chloride solution and 5 L of a 11 wt % citric acid solution were prepared, and then mixed to obtain an AlCit solution. A 5 wt % NaOH solution was prepared, the NaOH solution was slowly dropped into the AlCit solution, and quickly stirred until the pH value of the mixture solution reached 5.95, thereby obtaining a crosslinking agent.

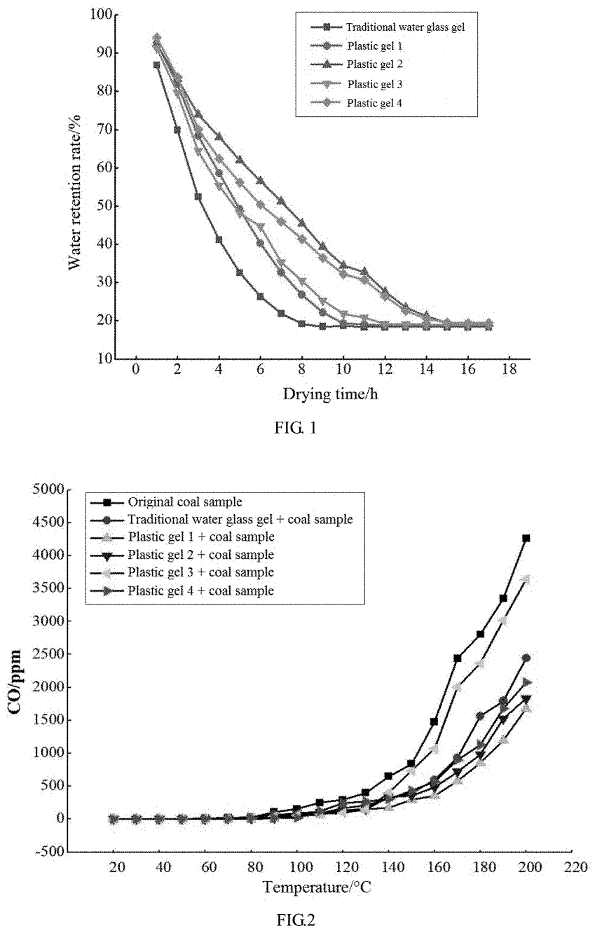

2 kg of pregelatinized starch was weighed and dissolved in 700 kg of water, and stirred until the polymer is sufficiently dissolved, thereby obtaining a polymer solution. Then, 8 kg of the prepared crosslinking agent was uniformly mixed with the polymer solution, 2 kg of glucono-δ-lactone (GDL) was added to the above solution, and stirred to its full dissolution, 20 kg of sodium bicarbonate was then added to the solution, and stirred to its full dissolution (the gel formation time can be reasonably controlled by adjusting the amount of the coagulant sodium bicarbonate according to actual needs), then 100 kg of coal ash was slowly added to the solution, and stirred to its uniform dispersion, thereby obtaining a component A. Finally, a certain amount of component B (water glass) was thoroughly mixed with the component A and the mixing continued until the coal ash particles no longer settled, thereby forming a plastic gel slurry (for the specific experimental procedure, reference can be made to FIG. 1 in other supporting documents).

By starting a grouting pump, the plastic gel slurry is pumped and sprayed on a burning coal pile. The plastic gel slurry seeps into every corner of the cracks of the coal pile due to its good permeability. The gel formation time can be reasonably controlled by adjusting the amount of the coagulant sodium bicarbonate, so that the gel is formed at a maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal masses so as to achieve a good ventilation sealing effect.

### Embodiment 2

10 L of a 20 wt % polyaluminum chloride solution and 5 L of a 11 wt % citric acid solution were prepared, and then mixed to obtain an AlCit solution. A 5 wt % NaOH solution was prepared, the NaOH solution was slowly dropped into the AlCit solution, and quickly stirred until the pH value of the mixture solution reached 5.96, thereby obtaining a crosslinking agent.

2 kg of carboxymethyl cellulose was weighed and dissolved in 700 kg of water, and stirred to its full dissolution, thereby obtaining a polymer solution. Then, 8 kg of the prepared crosslinking agent was taken and uniformly mixed with the polymer solution, 2 kg of glucono-δ-lactone (GDL) was added to the above solution, and then stirred to its full dissolution, 20 kg of sodium bicarbonate was added to the solution, and then stirred to its full dissolution (the gel formation time can be reasonably controlled by adjusting the amount of the coagulant sodium bicarbonate according to actual needs), then 100 kg of coal ash was slowly added to the solution, and then stirred to its uniform dispersion, thereby obtaining a component A. Finally, a certain amount of component B (water glass) is thoroughly mixed with the component A and the mixing continued until the coal ash particles no longer settled, thereby forming a plastic gel slurry.

By starting a grouting pump, the plastic gel slurry is pumped and sprayed on a burning coal pile. The plastic gel slurry seeps to every corner of the cracks of the coal pile due to its good permeability. The gel formation time can be reasonably controlled by adjusting the amount of the coagulant sodium bicarbonate, so that the gel is formed at the maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal masses so as to achieve a good ventilation sealing effect.

### Embodiment 3

10 L of a 20 wt % polyaluminum chloride solution and 5 L of a 11 wt % citric acid solution were prepared, and then mixed to obtain an AlCit solution. A 5 wt % NaOH solution was prepared, the NaOH solution was slowly dropped into the AlCit solution, and quickly stirred until the pH value of the mixture solution reached 5.97, thereby obtaining a crosslinking agent.

2 kg of sodium alginate was weighed and dissolved in 700 kg of water, and stirred to its full dissolution, thereby obtaining a polymer solution. Then, 8 kg of the prepared crosslinking agent was taken and uniformly mixed with the polymer solution, 2 kg of glucono-δ-lactone (GDL) was then added to the above solution, and stirred to its full dissolution, 20 kg of sodium bicarbonate was added to the solution and stirred to its full dissolution (the gel formation time can be reasonably controlled by adjusting the amount of the coagulant sodium bicarbonate according to actual needs), then 100 kg of coal ash was slowly added to the solution, and stirred to its uniform dispersion, thereby obtaining a component A. Finally, a certain amount of component B (water glass) is thoroughly mixed with the component A, and the mixing continued until the coal ash particles no longer settled, thereby forming a plastic gel slurry.

By starting a grouting pump, the plastic gel slurry is pumped and sprayed on a burning coal pile. The plastic gel slurry seeps to every corner of the cracks of the coal pile due to its good permeability. The gel formation time can be reasonably controlled by adjusting the amount of the coagulant sodium bicarbonate, so that the gel is formed at the maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal so as to achieve a good ventilation sealing effect.

### Embodiment 4

10 L of a 20 wt % polyaluminum chloride solution and 5 L of a 11 wt % citric acid solution were prepared, and then mixed to obtain an AlCit solution. A 5 wt % NaOH solution was prepared, the NaOH solution was slowly dropped into the AlCit solution, and quickly stirred until the pH value of the mixture solution reached 6.0, thereby obtaining a crosslinking agent.

2 kg of polyacrylamide was weighed and dissolved in 700 kg of water, and stirred to its full dissolution, thereby obtaining a polymer solution. Then, 8 kg of the prepared crosslinking agent was taken and uniformly mixed with the polymer solution, then 2 kg of glucono-δ-lactone (GDL) was added to the above solution, and stirred to its full dissolution, then 20 kg of sodium bicarbonate was added to the solution and stirred to its full dissolution (the gel formation time can be reasonably controlled by adjusting the amount of the coagulant sodium bicarbonate according to actual needs), then 100 kg of coal ash was slowly added to the solution and stirred to its uniform dispersion, thereby obtaining a component A. Finally, a certain amount of water glass (component B) is thoroughly mixed with the component A, and the mixing continued until the coal ash particles no longer settled, thereby forming a plastic gel slurry.

By starting a grouting pump, the plastic gel slurry is pumped and sprayed on a burning coal pile. The plastic gel slurry seeps to every corner of the cracks of the coal pile due to its good permeability. The gel formation time can be reasonably controlled by adjusting the amount of the coagulant sodium bicarbonate, so that the gel is formed at the maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal so as to achieve a good ventilation sealing effect.

Principle of Plastic Gel Formation:

It is Al³⁺ that performs crosslinking function during the plastic gel formation. Polynuclear hydroxyl bridged ions of aluminum can coordinate with —CONH₂ and —COO⁻, but the latter dominates. This coordination makes the system a complete network structure. Al³⁺ does not participate in the crosslinking reaction in the form of simple ions, but is crosslinked with polymers such as pregelatinized starch, polyacrylamide, carboxymethyl cellulose in the form of polynuclear hydroxyl bridged ions. Al³⁺ is used as a crosslinking point to crosslink the polymers together to form a network structure with a longer polymer chain (for its formation process, reference can be made to FIG. 2 in other supporting documents).

The relevant performance characterization data of gels of different components measured through experiments are shown in Table 1.

TABLE 1
Relevant performance characterization data of gels of different components

| | Gel category | | | | |
|---|---|---|---|---|---|
| | Traditional | Plastic gel 1 | Plastic gel 2 | Plastic gel 3 | Plastic gel 4 |
| | water glass gel | (Embodiment 1) | (Embodiment 2) | (Embodiment 3) | (Embodiment 4) |
| Gel formation | 553 | 543 | 317 | 552 | 233 |
| time/s | | | | | |
| Viscosity/ | 302 | 1387 | 1617 | 877 | 1723 |
| mPa · s | | | | | |
| Permeability | 48 | 59 | 91 | 83 | 114 |
| (time to flow | | | | | |
| through the | | | | | |
| glass tube)/s | 7.36 | 1.63 | 1.57 | 2.39 | 1.84 |
| Pulverization | | | | | |
| rate/% | | | | | |
| Strength/MPa | 0.90 | 0.99 | 1.02 | 0.97 | 0.99 |

Compared with the traditional water glass gel, the viscosity of the plastic gel is increased, which is conducive to sealing pores of the coal seam. Moreover, the plastic gel has good fluidity and wide permeation scope, and is also improved in strength. The pulverization rate of the plastic gel is 70-90% lower than that of the traditional water glass gel, so the pulverization resistance is significantly enhanced. In addition, after the traditional water glass gel and the plastic gel are placed in a drying oven and dried at 100° C. for 1 hour, the results show that the traditional water glass gel has cracked after losing some water, but the plastic gel remains intact. It can be seen that the prepared novel plastic gel effectively solves the problem of easy cracking in the traditional water glass gel consolidating bodies.

The experimental results and analysis of the water retention, inhibition characteristics, fire extinguishing characteristics and the like of the obtained materials (traditional water glass and plastic gel 1 to plastic gel 4) are shown in FIG. 1.

It can be found from FIG. 1 that the water retention of plastic gel 1 to plastic gel 4 is good. Because the introduction of AlCit makes multiple linear molecules crosslinked with each other into a dense network structure and water molecules are wrapped therein and cannot be lost easily, their water retention is good.

It can be seen from FIG. 2 that after drying at 100° C., the production amount of CO of each inhibited coal sample is lower than that of an original coal sample, and differs more and more obviously from the original coal sample along with the increase of the temperature, which indicates that the gel material has different degrees of inhibition on the oxidation of coal and has an increasing inhibition effect along with the increase of the temperature. The reasons are as follows: the gel can form a layer of dense colloid structure on the surface of the coal which effectively inhibits contact between coal and oxygen, and at the same time, the colloid contains a certain amount of water that can evaporate to effectively reduce the temperature of the coal, thereby reducing the oxidation rate of the coal mass. It can be seen from FIG. 2 that the plastic gel 1, the plastic gel 2 and the plastic gel 4 have a good inhibition effect for the following reasons: these gels have dense structure and strong intermolecular force, and after the gels are thoroughly mixed with the coal, the dense colloidal structure can effectively cover the surface of the coal during heating, thereby having a good inhibition effect.

A pure coal powder and a gel/coal are tested by infrared spectroscopy at different temperatures (for the results, reference can be made to FIG. 5 in other supporting documents). Hydroxyl and methylene are the main functional groups of coal and play a key role during spontaneous combustion of coal. After testing, the results show that as the temperature increases, the spectrum of pure coal decreases significantly in the wave number range of 3200-3600 cm⁻¹ and 2800-3000 cm⁻¹, which indicates that the hydroxyl and methylene of the coal participate in the reaction during heating. At 90° C., 120° C. and 180° C., the spectrum of the plastic gel 2+coal powder mixture has no obvious change in the range of 3200-3600 cm⁻¹, and has a slight change in the range of 2800-3000 cm⁻¹, which indicates that the plastic gel 2 has a significant inhibiting effect on the oxidation of hydroxyl and methylene during heating. When the temperature is 90° C. and 120° C., the spectral curves of the plastic gel 3+coal powder mixture in the wave number range of 3200-3600 cm⁻¹ and 2800-3000 cm⁻¹ basically coincide, which indicates that the plastic gel 3 can inhibit the oxidation of hydroxyl and methylene in coal powder at 90° C. and 120° C. When the temperature is 180° C., the infrared spectrum of the CMC/WG gel+coal mixture in the wave number range of 3200-3600 cm⁻¹ and 2800-3000 cm⁻¹ is significantly lower than that at 90° C. and 120° C., which indicates that the inhibiting effect of the plastic gel 3 on the oxidation of hydroxyl in coal powder becomes weaker at the temperature of 180° C. and the hydroxyl participates in the reaction.

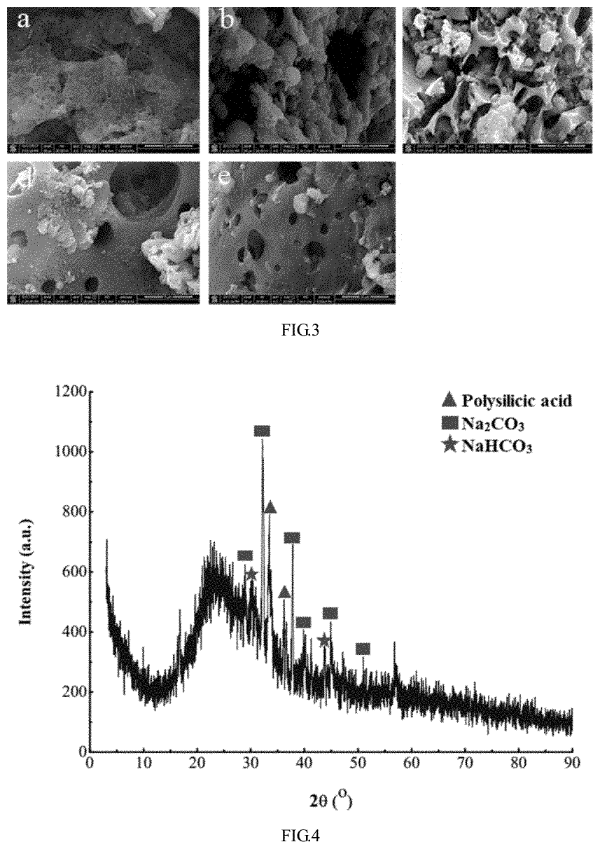

It can be clearly seen from FIG. 3a that the traditional water glass gel has a majority of pore structures, and the gel has a chaotic surface structure, thereby eliminating smooth and complete structure, which also proves the characteristics of low strength and easy cracking of the consolidating body. It can be seen from FIGS. 3b-c that there are spheres on the surface of the gel, which are SiO₂ produced in the gel reaction process (see Formula (1)); and there are white agglomerates in FIGS. 3c-e. After the white flocs are extracted and subjected to X-ray diffraction analysis in this study, it is inferred that the substance is Na₂CO₃ as shown in the results of FIG. 4. This is because in the gel formation process, the water glass absorbs H⁺ in the NaHCO₃ aqueous solution to generate SiO₂ and sodium carbonate (see Formula (1)). FIGS. 3d and e show that the surface of the composite gel added with crosslinking agent AlCit becomes smoother and denser, which indicates that Al³⁺ performs a crosslinking function to make the binding between different molecules tighter (for the crosslinking reaction process, reference can be made to FIG. 2 in other supporting documents) and the acting force more obvious, thereby realizing a more complete and denser structure.

Na₂SiO₃+NaHCO₃→nSiO₂+H₂O+Na₂CO₃ (1)

Gel fire extinguishing tests were performed on the traditional water glass gel, plastic gel 1, plastic gel 2, plastic gel 3 and plastic gel 4 (for the temperature changes over time, reference can be made to FIG. 8 in other supporting documents). The results show that with the passage of time, the temperature first increases and then decreases, where the temperature increase stage is a stage in which coal briquettes burn and the temperature decrease stage is a stage in which the gel is sprayed to extinguish fire. When the five gel materials of the same amount (500 mL) are used to extinguish the fire, the plastic gel can realize fast cooling during the fire extinguishing process, thereby producing a good fire extinguishing effect.

Tests of heat flow changes during fire extinguishment with gel were performed on the traditional water glass gel, plastic gel 1, plastic gel 2, plastic gel 3 and plastic gel 4 (for the heat flow changes over time, reference can be made to FIG. 9 in other supporting documents). The results show that when these materials are used during fire extinguishment, the heat radiation value decreases quickly for the reasons: the gel covers the surface of the coal briquettes during fire extinguishment and cuts off the propagation path of heat radiation. It can be concluded from the results that among the five materials, the traditional water glass gel has the highest heat radiation value in fire extinguishment, which indicates that the traditional water glass gel has the worst heat insulation effect while the plastic gels 1 to 4 have an obviously increasing heat insulation effect and can effectively insulate heat.

### Embodiment 5

30 L of a 10 wt % polyaluminum chloride solution and 20 L of a 5 wt % citric acid solution were prepared, and then mixed to obtain an AlCit solution. A 5 wt % NaOH solution was prepared, the NaOH solution was slowly dropped into the AlCit solution and quickly stirred until the pH value of the mixture solution reached 6.01, thereby obtaining a crosslinking agent.

0.1 kg of super absorbent resin was weighed and dissolved in 520 kg of water, and stirred to its full dissolution, thereby obtaining a polymer solution. Then, 4 kg of the prepared crosslinking agent was taken and uniformly mixed with the polymer solution, then 10 kg of ammonium bicarbonate was added to the solution and stirred to its full dissolution (the gel formation time can be reasonably controlled by adjusting the amount of the coagulant ammonium bicarbonate according to actual needs), then 70 kg of bentonite was slowly added to the solution and stirred to its uniform dispersion, thereby obtaining a component A.

Finally, 70 kg of component B (water glass) was thoroughly mixed with the component A, and the mixture is stirred until the bentonite particles no longer settled, thereby forming a plastic gel slurry (where the water glass, that is, the sodium silicate aqueous solution, has a Baume degree of 20, a modulus of 2 and a mass concentration of 5%).

By starting a grouting pump, the plastic gel slurry is pumped and sprayed on a burning coal pile. The plastic gel slurry seeps to every corner of cracks of the coal pile due to its good permeability. The gel formation time can be reasonably controlled by adjusting the amount of the coagulant ammonium bicarbonate, so that the gel is formed at the maximum seepage range. The formed plastic gel can cover the surface of the high-temperature ignition source to isolate oxygen, steadily reduces the temperature of the ignition source, effectively reduces the heat radiation and the amount of CO produced, and will not produce the re-ignition phenomenon. In addition, the gel can adhere to the cracks of the coal so as to achieve a good air leakage blocking effect.

### Embodiment 6

10 L of a 30 wt % polyaluminum chloride solution and 60 L of a 20 wt % citric acid solution were prepared, and then mixed to obtain an AlCit solution. A 5 wt % NaOH solution is prepared, the NaOH solution was slowly dropped into the AlCit solution, and the mixture was quickly stirred until the pH value of the mixed solution reached 6.04, thereby obtaining a crosslinking agent.

30 kg of sodium alginate was weighed and dissolved in 800 kg of water, and the mixture was stirred until the polymer was sufficiently dissolved, thereby obtaining a polymer solution. Then, 100 kg of the prepared crosslinking agent was uniformly mixed with the polymer solution, 150 kg of potassium bicarbonate was added to the solution, the mixture was stirred until the potassium bicarbonate was sufficiently dissolved (the gel formation time can be reasonably controlled by adjusting the amount of the coagulant potassium bicarbonate according to actual needs), then 200 kg of coal ash was slowly added to the solution, and the mixture is stirred until the coal ash is dispersed uniformly, thereby obtaining a component A.

Finally, 200 kg of component B (water glass) was thoroughly mixed with the component A, and the mixture was stirred until the coal ash particles no longer settled, thereby forming a plastic gel slurry (where the water glass, that is, the sodium silicate aqueous solution, has a Baume degree of 40, a modulus of 4 and a mass concentration of 40%).

By starting a grouting pump, the plastic gel slurry is pumped and sprayed on a burning coal pile. The plastic gel slurry seeps to every corner of the cracks of the coal pile due to its good permeability. The gel formation time can be reasonably controlled by adjusting the amount of the coagulant potassium bicarbonate, so that the gel is formed at the maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal so as to achieve a good ventilation sealing effect.

### Embodiment 7

15 L of a 20 wt % polyaluminum chloride solution and 20 L of a 15 wt % citric acid solution were prepared, and then mixed to obtain an AlCit solution. A 5 wt % NaOH solution was prepared, the NaOH solution was slowly dropped into the AlCit solution, and quickly stirred until the pH value of the mixture solution reached 6.02, thereby obtaining a crosslinking agent.

15 kg of carboxymethyl cellulose was weighed and dissolved in 600 kg of water and stirred to its full dissolution, thereby obtaining a polymer solution. Then, 50 kg of the prepared crosslinking agent was taken and uniformly mixed with the polymer solution, then a certain amount of slow release agent was added to the above solution and stirred to its full dissolution, then 100 kg of sodium carbonate was added to the solution and stirred to its full dissolution (the gel formation time can be reasonably controlled by adjusting the amount of the coagulant sodium carbonate according to actual needs), then 150 kg of coal ash was slowly added to the solution and stirred to its uniform dispersion, thereby obtaining a component A. Finally, 100 kg of component B (water glass) was thoroughly mixed with the component A, and the mixing continued until the coal ash particles no longer settled, thereby forming a plastic gel slurry (where the water glass, that is, the sodium silicate aqueous solution, had a Baume degree of 30, a modulus of 3 and a mass concentration of 20%).

By starting a grouting pump, the plastic gel slurry is pumped and sprayed on a burning coal pile. The plastic gel slurry seeps to every corner of the cracks of the coal pile due to its good permeability. The gel formation time can be reasonably controlled by adjusting the amount of the coagulant sodium carbonate, so that the gel is formed at the maximum seepage scope. The formed plastic gel can cover the surface of the high-temperature ignition source to isolate oxygen, steadily reduces the temperature of the ignition source, and effectively reduces the heat radiation and the production amount of CO, thereby eliminating reoccurrence of the re-ignition phenomenon. In addition, the gel can adhere to the cracks of the coal mass so as to achieve a good ventilation sealing effect.

Of course, the above description is not limiting of the present invention, and the present invention is not limited to the above examples. Changes, modifications, additions or substitutions made by those skilled in the art within the essential scope of the present invention shall also fall within the protection scope of the present invention.

1. A plastic gel material for preventing spontaneous combustion of coal, comprising water, a crosslinking agent, a toughener, a coagulant, an aggregate and water glass.

2. The plastic gel material for preventing spontaneous combustion of coal according to claim 1, wherein the water glass has a Baume degree of 20-40, a modulus of 2-4 and a mass concentration of 5-40%.

3. The plastic gel material for preventing spontaneous combustion of coal according to claim 2, comprising 52-80 wt % of water, 0.4-10 wt % of crosslinking agent, 0.01-3 wt % of toughener, 1-15 wt % of coagulant, 7-20 wt % of aggregate and 7-20 wt % of water glass.

4. The plastic gel material for preventing spontaneous combustion of coal according to claim 1, wherein the crosslinking agent is prepared by firstly mixing a polyaluminum chloride solution and a sodium citrate solution and then adjusting a pH value of the mixture with an NaOH solution.

5. The plastic gel material for preventing spontaneous combustion of coal according to claim 4, wherein the pH value is 5.95-6.05.

6. The plastic gel material for preventing spontaneous combustion of coal according to claim 4, wherein a concentration of the polyaluminum chloride solution is 10-30 wt %, a concentration of the sodium citrate solution is 5-20 wt %, and the two solutions are mixed in a mass ratio of 3:1-1:4 to obtain an AlCit solution.

7. The plastic gel material for preventing spontaneous combustion of coal according to claim 1, wherein the coagulant is one or more of potassium bicarbonate, sodium bicarbonate, ammonium bicarbonate, sodium carbonate and glucono-δ-lactone.

8. The plastic gel material for preventing spontaneous combustion of coal according to claim 1, wherein the toughener is one or more of super absorbent resin, pregelatinized starch, sodium alginate, carboxymethyl cellulose and polyacrylamide.

9. The plastic gel material for preventing spontaneous combustion of coal according to claim 1, wherein the aggregate is bentonite or coal ash.
